(19) United States
(12) Patent Application Publication
(10) Pub. No.: US 2003/0030665 A1
(43) Pub. Date: Feb. 13, 2003

(54) Method, user interface module, intermediate modules as well as network management system equipped therewith for operating a user interface module

(75) Inventor: Heinz Tillmanns, Stahnsdorf (DE)

Correspondence Address: SUGHRUE, MION, ZINN,, MACPEAK & SEAS, PLLC, 2100 Pennsylvania Avenue, N.W., Washington, DC, 20037-3213, US

(73) Assignee: ALCATEL

(21) Appl. No.: 10/201,238

(22) Filed: Jul. 24, 2002

(30) Foreign Application Priority Data
Aug. 13, 2001 (EP) 01 440 261.4

(51) Int. Cl. G09G 5/00

(52) U.S. Cl. 345/744

(57) ABSTRACT

The present invention relates to a method of operating a first user interface module which can generate first output commands for outputting a first user interface at output means and receive input commands related to the first user interface. The invention further relates to a (second) user interface module and to intermediate modules for carrying out the method, and to a network management system or a computer of a network management system which are equipped with such a user interface module and/or intermediate module.

### BACKGROUND OF THE INVENTION

The invention is based on a priority application EP 01 440 261 which is hereby incorporated by reference.

The present invention relates to a method of operating a first user interface module which can generate first output commands for outputting a first user interface at output means and receive input commands related to the first user interface. The invention further relates to a (second) user interface module and an intermediate module for carrying out this method and to a network management system or a computer of a network management system which is equipped with such a user interface module and/or such intermediate module(s).

To an increasing extent, apparatus of various descriptions, such as telephone systems, building installations, navigation systems, or the like, can be operated by means of so-called graphical user interfaces (GUIs). The user interfaces are output by computer systems, for instance personal computers. A user interface displays one or more states of the apparatus controllable by it. The operator of the user interface can enter commands, for instance by means of a keyboard or a mouse, which are then forwarded by the user interface to the apparatus controllable by it.

User interfaces are typically generated by user interface modules whose program code is executed by a computer. The user interface modules send to the computer output commands by means of which the computer generates the respective user interface, for instance a symbol of the apparatus to be controlled. When the operator of the user interface enters commands, for instance by means of a keyboard, the respective input commands are routed by the computer to the user interface module.

From an operator's point of view, user interfaces should ideally be of the same design; in particular, different user interfaces should be based on the same operating concept. In the case of Windows programs, for example, it is known, that the respective menu option at the extreme left is “file”. In addition, it is desirable that different user interfaces should look alike, i.e., that they should follow a so-called style guide. In short, the operator desires a uniform “look and feel”.

In practice, however, this is frequently not realizable. In a network management system, for example, a switching center may have to be controlled via a user interface of a first manufacturer, a call center via a user interface of a second manufacturer, and a database via a user interface of a third manufacturer. Each manufacturer supplies a user interface of its own for its respective apparatus. The operator of the network management system must then adopt himself to the different user interfaces. In the case of one user interface, for example, an error message may be indicated by a red light spot, and in the case of another user interface, it may be indicated by a yellow light spot and an audible alarm. For the operator, this is difficult to handle, so that operator errors are likely.

A solution could be, for example, to develop a common user interface with which all apparatus to be controlled by the respective network management system is operator-controllable. However, the manufacture of such a user interface is not only complicated and costly but in many cases impossible, since the interface between an apparatus and the proprietary user interface with which the apparatus is controllable is frequently not disclosed by the respective manufacturer of the apparatus and the associated proprietary user interface. It may even be that a proprietary user interface is inseparably connected with the apparatus controllable by it; for example, a user interface module may form part of a database application controllable by the proprietary user interface.

### SUMMARY OF THE INVENTION

It is therefore an object of the present invention to simplify the operation of one or more existing, proprietary user interface modules.

To attain this object, there are provided: a method according to the technical teaching of claim 1 as well as a user interface module, intermediate modules, and a network management system or a computer of a network management system comprising such a user interface module or intermediate module as set forth in further independent claims.

The idea underlying the invention is to connect a second user interface module ahead of or beside a proprietary user interface module which is provided for controlling a device, such as a network element of a telecommunications network. The connection between the first user interface module and the device controlled and monitored by it is preserved, while the connection between the first user interface module and input/output means runs via the second user interface module.

The first user interface module is, for example, a proprietary module, while the second user interface module is optimally adapted to the needs of the operator, for instance by having a desired “look and feel”. The output commands sent by the first user interface module for generating the first user interface are transferred to the second user interface module, so that the latter knows, so to speak, how the first user interface currently has to look. On the basis of the first user interface, the second user interface module then creates its own, second user interface, where in the event of an error message from the user interface to be operated, for example, a red light spot is produced, not a yellow one as in the case of the first user interface. When the operator enters data at the second user interface, for instance by clicking on the aforementioned red light spot to learn the cause of the error in plaintext, this input will be transferred as second input commands to the second user interface module, which will generate from the input commands related to the second user interface first input commands related to the first user interface, which will then be transferred to the first user interface module. The second user interface module simulates, so to speak, an operator input with respect to the first user interface, i.e., from the point of view of the first user interface module it looks as if an input operation was performed at its user interface.

It is to be understood that in this manner, the second user interface module can also operate further proprietary user interface modules, with a common “look and feel” being made available for all subordinate proprietary user interface modules. Different user interfaces can be integrated under a common user interface in a simple manner and at low cost.

The interface between the proprietary user interface module(s) and the apparatus controllable thereby is not affected by the invention, so that it need riot be known for a development of a user interface module according to the invention. In addition, under certain circumstances, essential functions of a proprietary user interface module, such as plausibility checks on operator inputs, are preserved.

Advantageous developments of the invention are apparent from the dependent claims and the description.

In principle, both the first, proprietary user interface and the second user interface, which functionally is disposed ahead of or beside the first user interface, can be displayed in parallel, for instance on different screens or on two screen areas side by side. Advantageously, however, the output commands relating to the first user interface are at least partly intercepted and discarded. Then, the first, proprietary user interface is not output or is output only in a restricted form. The first, proprietary user interface may also be completely invisible to the operator. It may, for instance, be moved to a virtual screen area which is not displayed on a real, visible screen area.

Advantageously, the output means available to the user interfaces, or other resources allocated to the output means, are made available with priority not to the first, proprietary user interface module, but to the second user interface module. If, for example, a color is to be selected from a color table which makes available each color only once, this color will preferably be made available to the second user interface module, so that the latter will get an optimum color representation. This can be accomplished, for example, by turning on the second user interface module prior to the first user interface module, so that only the output means not used by the second user interface module, and resources allocated thereto, will be made available to the first user interface module.

In principle, user interface modules can have direct access to output means, for instance by sending graphic commands directly to the graphics card provided for output. Preferably, however, an output module is provided for controlling the output means. This can be, for example, a part of the respective operating system used or, for instance in an X-Windows environment, a so-called X server. In such an environment, it is particularly simple to connect the second user interface module between the first user interface module and the output module, so to speak. The second user interface module can at least listen in on the communication between the first user interface module and the output module or even completely receive this communication instead of the output module, in which case the output commands of the first user interface module are redirected to the second user interface module.

What was explained in the preceding paragraph with reference to the output means applies analogously to the input means, for instance keyboard and mouse. These, too, are preferably monitored by an input module, such as an X server, which transfers the second input commands, related to the second user interface, to the second user interface module.

In principle it is also possible to transfer to the first user interface module not only (first) input commands of the second user interface but also first input commands entered directly at the input means and related to the first user interface, so that an operator can control a device not only via the second, operator-friendly user interface but also via the first, proprietary interface.

Preferably, an intermediate module is connected between the first and second user interface modules for transferring the output commands received from the first user interface module, or copies thereof, to the second user interface module. This intermediate module, or a separate intermediate module, can also be provided for receiving the first input commands, related to the first user interface, from the second user interface module and passing them on to the first user interface module. The aforementioned intermediate module or the aforementioned separate intermediate modules can also be connected between, on the one hand, the first and second user interface modules and, on the other hand, the input means and/or the output means. Then, the intermediate module(s) is (are) the link(s), so to speak, between the user interface modules and the input/output means.

The intermediate module can modify the output commands from the first user interface module by means of a transformation table, so that these commands are related to a coordinate system assigned to the second user interface. This approach is also possible in the opposite direction. The first input commands, generated by the second user interface module, can also be transformed by the intermediate module by means of the transformation table, with a transformation taking place, for example, from coordinates related to the second user interface to coordinates related to the first user interface.

The second user interface need not contain all the elements of the first user interface. For example, part of the information contained in the first output commands can be suppressed by the second user interface module to implement a simple operating concept. However, the second user interface module can add to its second user interface further information, such as a help system not available in the first user interface.

The invention can be used in arbitrary interface environments. In a particularly preferred variant of the invention, however, the invention is implemented in connection with a network management system, with the first user interface module serving to monitor and control a network resource managed by the network management system, particularly a network element of the network.

The first, proprietary user interface module can be a user interface module which communicates directly with the device to be operated, for instance by sending control commands to or receiving messages from this device.

In a preferred variant of the invention, the first user interface module serves to control and monitor an application module, particularly an application program. The application module may be, for instance, a database application or a control and monitoring module for a network element such as a switching center, a remote switching unit, or the like.

### BRIEF DESCRIPTION OF THE DRAWINGS

The invention will become more apparent from the following description of several embodiments taken in conjunction with the accompanying drawings, in which:

FIG. 1 shows a network management system according to the invention for managing network elements NE1 to NE3, comprising control computers IS1, IS2, AS and a control terminal C2;

FIG. 2 is a part of FIG. 1 showing components of control computer IS1, particularly an intermediate module according to the invention, IM, a first, proprietary user interface module PUI2, and a second user interface module CUI2, the user interface module according to the invention, which is associated with the first user interface module;

FIG. 3 is a schematic, functional representation of the control computer IS1 of FIGS. 1 and 2;

FIG. 4 is a functional representation of the control computer IS2 of FIG. 1; and

FIG. 5 is a schematic representation of the user interface module CUI1 of FIG. 1.

The network management system NMS controls and monitors a network NW, for instance a telecommunications network, such as an ISDN network (ISDN=integrated services digital network), and/or a computer network. The network elements NE1 to NE3 are, for instance, switching centers, switches, routers, workstations, or standalone computers.

The network management system NMS represents a computer network in itself, since it contains interconnected control computers IS1, IS2, and AS as well as a control-terminal computer C2. Computers IS1, IS2, AS, and C2 are interconnected by a local area network (LAN) and/or a wide area network (WAN), for example. Network management system NMS and network elements NE1 to NE3 are interconnected via a separate control network (not shown in detail), such as a telecommunications management network (TMN).

Associated with the network elements NE1, NE2 NE3 are application modules A1, A2, A3 which are designed as control and monitoring modules for the respective network elements NE1 to NE3. Application modules A1 to A3 can send control commands, e.g., parameter messages, to network elements NE1, NE2, and NE3, respectively, and receive messages from the latter, e.g., messages about malfunctions, capacity usage, or other system states of the respective network element NE1, NE2, or NE3. For the communication between network elements NE1 to NE3 and the respective application modules A1 to A3, links V1, V22, and V32, respectively, are provided which run via a control and monitoring network of network management system NMS.

Application module A1 forms part of a proprietary user interface module PUI1; it is, for example, a subfunction of the same. The program code of application module A1 or of user interface module PUI1 is executed by control computer IS1. By means of user interface module PUI1 or the application module A1 contained therein, network element NE1 can be controlled and monitored. User interface module PUI1 is produced by the manufacturer of network element NE1, for example, and is optimally adapted to the requirements of network element NE1. The user interface made available by user interface module PUI1, however, is a proprietary interface.

Application modules A2, A3 are independent program modules whose program code is executed by control computer AS. Control computer AS is, for instance, a workstation with storage means, one or more processors serving as control means, and input/output interfaces, such as one or more Ethernet interface cards. Control computer AS may further comprise input means, such as a keyboard and/or a mouse. The control means (not shown) of control computer AS can execute the program code of application modules A1, A2 and of a database application DB, which also forms an application module. Control computer AS can also be referred to as an application server. It has a relatively high computing power and can also control further application modules (not shown), such as further control and monitoring modules for network elements (not shown), as well as other applications, such as further database applications.

Associated with application modules A2, A3, and DB are proprietary user interface modules PUI2, PUI3, and PUI4, respectively, with which the respective application modules A2, A3, and DB are operable. User interface module PUI2 is operated by control computer IS1, and user interface modules PUI3, PUI4 are operated by control computer IS2, i.e., control computer IS1 executes the program code of user interface module PUI2, and control computer IS2 executes the program code of user interface modules PUI3, PUI4. Application modules A2, A3, and DB are connected to the associated user interface modules PUI2, PUI3, and PUI4 by links V21, V31, and V4, respectively, which may run via a computer network, for example, such as a LAN.

In the embodiment, user interface modules PUI2, PUI3, PUI4 are remote modules, which could also be called “client modules”, i.e., they can be operated on the same computer as the application module operated by them or, as in the present case, by separate computers, here the control computers IS1, IS2, as required.

Like the user interface module PUI1, the user interface modules PUI2-PUI4 are proprietary modules which are adapted by the respective manufacturer to the functionality of the respective application module to be operated, A2, A3, DB. Each of the four user interface modules PUI1-PUI4 generates an individual user interface, in the sense of the invention a first user interface, so that the operator(s) of the network management system NMS would have to adapt himself or herself (themselves) to individual, different user interface designs if he or she (they) wanted to operate the user interfaces of the user interface modules PUI1-PUI4 directly. Replacing the proprietary user interface modules PUI1-PUI4 by one or more user interface modules which generate a uniform user interface is impossible or very difficult: Application module A1, for example, is part of user interface module PUI1, so that in order to control network element NE1, for example, it would be necessary to program not only a user interface module but also an application module A1. The interfaces between the user interfaces PUI2-PUI4 and the application modules A2, A3, and DB, respectively, may be of a relatively complicated design, for instance because plausibility checks are performed in the respective user interface modules PUI2-PUI4, and, to aggravate the problem, are possibly not disclosed by the respective manufacturer.

Therefore, in the embodiment, user interface modules CUI1, CUI2, and CUI3, in the sense of the invention second user interface modules, are provided, which, from a logical point of view, are disposed ahead of or beside the proprietary, first user interface modules PUI1-PUI4. The second user interface modules CUI1-CUI3 generate user interfaces which have a common look and follow a common operating concept, i.e., they have a “common look and feel”. The user interfaces generated by the second user interface modules CUI1 to CUI3 follow a common style guide. In the present case, they are graphical user interfaces (GUIs).

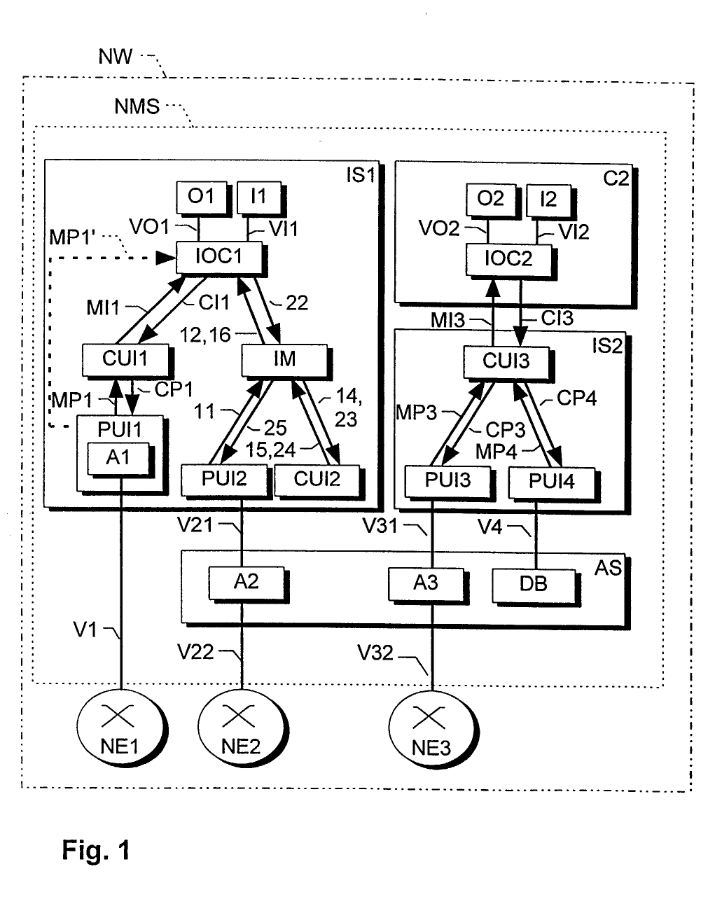

The second user interface module CUI1 is associated with the first user interface module PUI1, the second user interface module CUI2 is associated with the first user interface module PUI2, and the second user interface module CUI3 is associated with the two first user interface modules PUI3, PUI4. FIG. 1 shows three different variants of how the second user interface modules CUI1-CUI3 can be disposed ahead of or beside the first user interface modules PUI1-PUI4.

The second user interface module CUI1 is associated with and disposed directly above a single first user interface module, the user interface module PUI1. The second user interface module CUI2 is also associated with a single user interface module PUI2, but it is disposed beside the latter and connected to it via an intermediate module IM. The second user interface module CUI3 is associated with and disposed directly above two first user interface modules PUI3, PUI4.

User interface module PUI1 sends its first output commands MP1 for generating a first, proprietary user interface not directly to an input/output module IOC1, e.g., an X server, but to the second user interface module CUI1. In this manner, the latter is informed of the user interface generated by the proprietary user interface module PUI1 and, based on this user interface, can generate a more operator-friendly user interface of its own. User interface module CUI1 receives the first output commands MP1 via receiving means RCVP and generates second output commands MI1, for instance by means of a transformation table TRA, which it then sends with sending means SNDP to the input/output module IOC1. The receiving means RCVP and the sending means SNDP are program functions, for example.

The transformation table TRA contains allocation rules which determine, for example, that in the second user interface generated by user interface module CUI1, an error message to be output as a yellow picture element is a red triangular screen area.

The transformation table TRA may also contain a coordinate transformation which defines, for example, that in the second user interface generated by user interface module CUI1, the aforementioned picture element has to appear not in a screen area at the lower left, as in the case of the first, proprietary user interface, but in a screen area at the upper right. In addition, it is possible to store at least part of the first output commands in the transformation table TRA or in any other memory area. An output command MP1 with a plaintext message, for example, could be stored in this way. As the second output command MI1, a warning spot or a triangular warning indication, for example, will first be output at the user interface. Only when the operator clicks on this indication will the plaintext be output, with recourse being had to the text of the first output command MP1.

An input/output module IOC1 controls output means O1 which contain display devices DIS1, DIS2, e.g., visual display screens. The output means O1 may also incorporate loudspeakers, flashing indicators, vibration indicators, or the like. At the output means O1, user interfaces, for instance the user interface generated by user interface module CUI1, can be output, the output being in the form of graphic symbols, text elements, warning noise, or the like. The input/output module controls the output means O1 via a link VO1, for instance a cord or the like. Furthermore, the input/output module IOC1 monitors input means I1 which contain a keyboard KEY and a mouse MOU, for example. Inputs at the input means I1 are signaled to the input/output module IOC1 via a link VI1.

As mentioned, the input/output module IOC1 may be a so-called X server, which is customary particularly in the UNIX operating system. But in other operating systems, too, such as Windows or OS/2, the input/output means proper are controllable not directly by application or user interface program modules but only with the assistance of the respective operating system, which includes input/output modules for this purpose, which may form an integral part of the respective operating system. It is to be understood that a separate output module and a separate input module may be provided for controlling the output means and input means, respectively.

Input commands entered by an operator at the user interface generated by user interface module CUI1 are captured by input/output module IOC1, which sends them as (second) input commands CI1 to user interface module CUI1. An input command CI1 is generated, for example, when operating the keyboard KEY or clicking the mouse MOU on a symbol of the respective user interface. User interface module CUI1 receives the input commands CI1 with receiving means RCVP and forms (first) input commands CP1 by means of the transformation table TRA which are related to the user interface generated by the proprietary user interface module PUI1.

In the process, user interface module CUI1 may also perform plausibility checks or the like. Furthermore, operator actions with respect to the first and second user interfaces may be different: In the case of the user interface generated by user interface module CUI1, for example, a keyboard entry may be necessary, for which an operation with the mouse MOU would be required in the case of the user interface generated by the proprietary user interface module PUI1. In such a case, the user interface module CUI1 simulates the necessary mouse input, i.e., it converts a keyboard input according to a (second) input command CI1 into a (first) input command CP1 which signals a mouse input.

In the example just described, the output commands MP1 were all routed to user interface module CUI1, with the latter simulating the behavior of input/output module IOC1, for example. In that case, the user interface generated by the first user interface module PUI1 is not output at the output means O1. In a variant of the invention, however, it is also possible to route the first output commands MP1 not only to user interface CUI1 but also, as output commands MP1′, directly to input/output module IOC1. In accordance with the output commands MP1′, input/output module IOC1 outputs a first user interface, assigned to user interface module PUI1, and in accordance with the second output commands MI1, it outputs a second user interface, assigned to the user interface module CUI1. For example, the first user interface could be displayed on display device DIS1, and the second user interface on display device DIS2. It is also conceivable that the first user interface is output in an invisible, virtual output area which can be made visible on either of the display devices DIS1 and DIS2 when required, for instance by an appropriate operator action.

The output commands MP1, as shown in the embodiment, can be sent directly to user interface module CUI1, for instance by notifying the user interface module PUI1 of the respective destination of the output commands MP1. It is also possible, however, that user interface module PUI1 sends the output commands MP1 to input/output module IOC1, e.g., writes them into an input buffer of input/output module IOC1. User interface module CUI1 can check this input buffer on a regular basis, e.g., cyclically and/or in response to a receipt message from input/output module IOC1 upon receipt of an output command MP1, and simultaneously read out the output commands MP1. Alternatively it is possible that input/output module IOC1 sends the output commands MP1 or copies thereof to user interface module CUI1.

Another variant of the invention will now be explained with reference to the (second) user interface module CUI3, which is disposed ahead of the proprietary, first user interface modules PUI3, PUI4. Unlike user interface module CUI1, user interface module CUI3 is disposed ahead of more than one proprietary user interface module, namely two modules PUI3, PUI4, and provides a common user interface for the latter. Accordingly, the operator has to do with a single, uniform user interface rather than two proprietary user interfaces, which facilitates operator control.

Another difference from the variants in connection with user interface module CUI1 consists in the fact that the (second) user interface generated by user interface module CUI3 is not displayed by control computer IS2 itself, but that the control terminal C2 is provided for this purpose. Control terminal C2 is, for example, an X terminal, which is basically of a very simple design: It comprises control means (not shown), for instance a processor, and storage means (not shown) as well as output means O2, e.g., monitors, buzzers, or the like, and input means I2, e.g., keyboard and mouse. The input means I2 and the output means O₂ are controlled and monitored by an input/output module IOC2, e.g., an X server application, via links VO1 and VO2, respectively. Control computer IS2 and control terminal C2 can be physically distant from each other. Furthermore, control computer IS2 may have additional control terminals associated with it (not shown).

User interface module CUI3 receives from the first user interface module PUI3 first output commands MP3, with which a user interface assigned to user interface module PUI3 is generable, and from user interface module PUI4 first output commands MP4, with which a proprietary first user interface assigned to user interface module PUI4 is generable. From the output commands MP3, MP4, the second user interface module CUI3 forms output commands MI3, for instance by means of a transformation table and/or other transformation rules. From the output commands MI3, input/output module IOC2 generates a second user interface, which is assigned to user interface module CUI3, and outputs it at output means O2.

In the opposite direction, operator inputs at input means I2 with respect to the second user interface, which is assigned to user interface module CUI3, are signaled by input/output module IOC2 to user interface module CUI3 as input commands CI3. From the input commands CI3, user interface module CUI3 generates input commands CP3 or CP4, depending on whether the respective input relates to the proprietary first user interface module PUI3 or PUI4. This, too, can be done using the aforementioned transformation table or other transformation rules. The transformation table may, for instance, contain information as to whether a symbol addressable by double-clicking, for example, or an input field of the user interface generated by user interface module CUI3 is assigned to the user interface generated by the proprietary user interface module PUI3 or to the user interface generated by the proprietary user interface module PUI4. Accordingly, in the event of an input action relating to the symbol or the input field, user interface module CUI3 can decide whether the respective input command CI3 has to be converted to a an input command CP3 for user interface module PUI3 or to an input command CP4 for user interface module PUI4. Then, the transformation table also performs the function of an allocation table, so to speak.

The superposition of a common user interface over two or more proprietary user interfaces opens up further possibilities, both in the display direction and in the opposite direction, the control direction. For example, in an input field which is provided in a user interface made available by user interface module PUI3 and which is displayed by the user interface generated by user interface module CUI3, a menu can be displayed which is taken from the user interface made available by user interface module PUI4. The elements of the menu can originate from database application DB, for example. Furthermore, user interface module CUI3 can generate an input command CP3 and, at the same time, an output command CP4 in response to a single input command CI3. A typical example of such an input command could be, for example, a stop command with which the operation of application modules DB and A3 or of network element NE3 is to be suspended simultaneously in the event of a malfunction.

A further variant of the invention will now be explained with reference to the user interface module CUI2. Unlike user interface modules CUI1 and CUI3, user interface module CUI2 does not “cut in” on the data stream between one or more proprietary user interface modules and the input and output means directly but uses an intermediate module IM for this purpose.

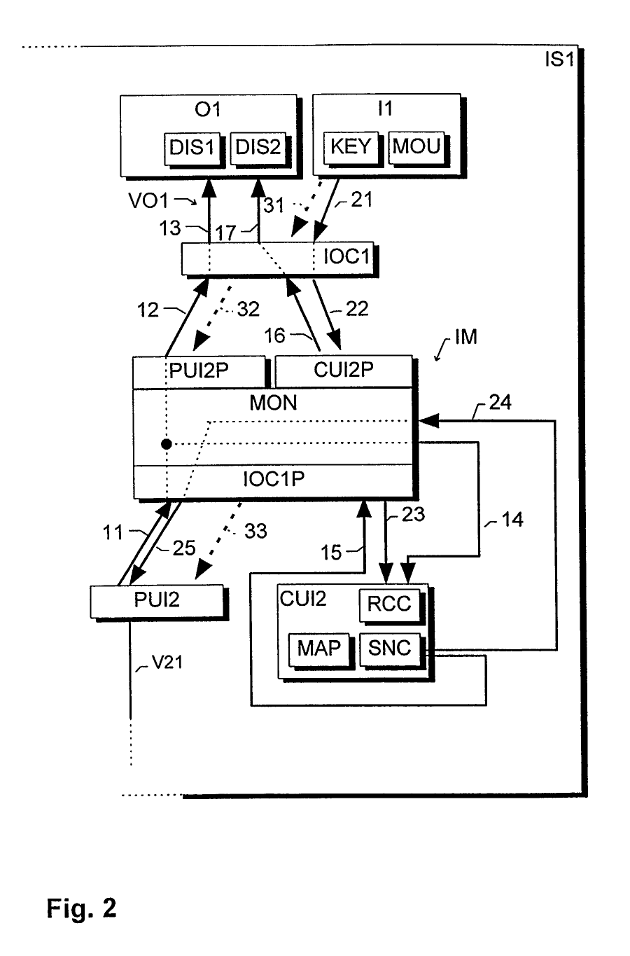

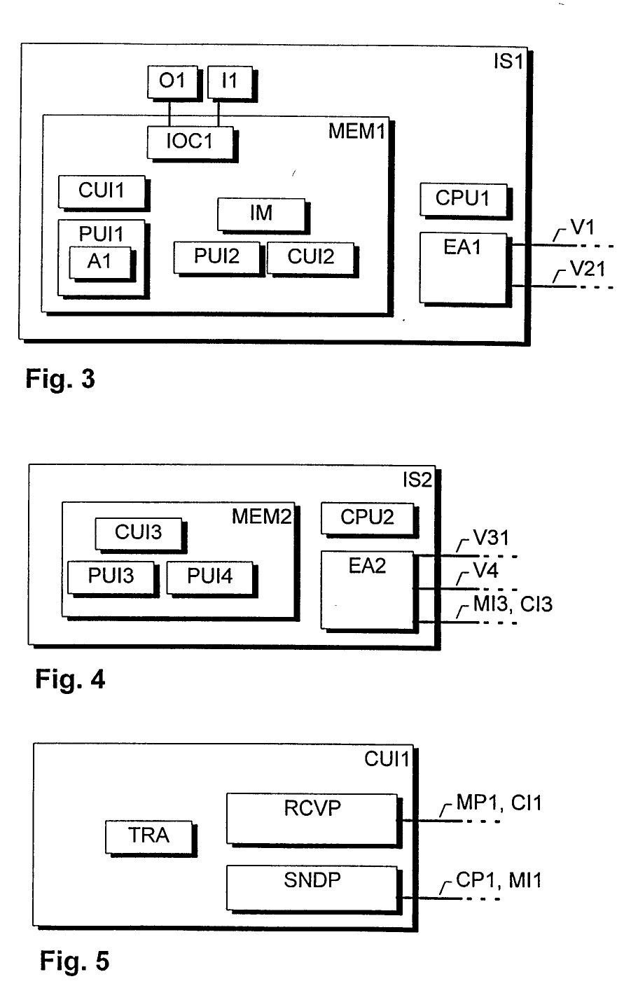

In the present case, the intermediate module IM is a program module whose program code is executed by control computer IS1. The intermediate module IM, whose details are shown schematically in FIG. 2, behaves toward user interface modules PUI2, CUI2 like an input/output module, for which purpose it includes receiving and sending means IOC1P. The receiving and sending means IOC1P behave in a similar manner as the input/output module IOC and can be implemented with a so-called X server proxy, for example. Toward the input/output module IOC1, input/output means PUI2P, which are associated with user interface module PUI2, and CUI2P, which are associated with user interface module CUI2, are provided in the intermediate module IM. The input/output means PUI2P and CUI2P can be implemented with so-called X client proxies, for example. The input/output means PUI2P simulates the behavior of user interface module PUI2 toward input/output module IOC1, and the input/output means CUI2P simulates the behavior of user interface module CUI2. Connected between the transmitting and receiving means IOC1P on the one hand and the sending and receiving means PUI2P, CUI2P on the other hand is a switching and copying means MON which switches messages between the transmitting and receiving means IOC1P, PUI2P, and CUI2P and, if necessary, passes them on as copies, which is explained in more detail below.

From the X-Windows world, a so-called X-monitor daemon is known which, like the switching and copying means MON, is connected between an X server proxy and a single X client proxy to monitor the communication between a single X client and an X server. The intermediate module IM shown in FIG. 2 leans on this concept, which, however, is modified and further developed in accordance with the invention, as will become apparent from the following description of the function of the intermediate module IM.

The proprietary user interface module PUI2 sends output commands 11 for generating a user interface to the intermediate module IM. The intermediate module IM routes the output commands 11 as output commands 12 to the input/output module IOC1, e.g., an X server as mentioned above, which generates control commands 13 from the output commands 12 and sends them to the output means O1. In this manner, a symbol, for example, is displayed on display device DIS1. The intermediate module IM can route the output commands 11 as output commands 12 to the input/output module IOC1 unmodified or after modification, for instance by means of a coordinate transformation. In the present case, the intermediate module IM copies the output commands 11 and passes them as output commands 14 to the (second) user interface module CUI2, which receives the output commands 14 with its receiving means RCC. By means of a transformation table MAP and/or other transformation rules, user interface module CUI2 generates output commands 15 from the output commands 14 and sends them with sending means SNC to intermediate module IM. The output commands 15 serve to output a second user interface which is assigned to user interface module CUI2, and are transferred as unmodified or coordinate-transformed output commands 16 from intermediate module IM to input/output module IOC1. In accordance with the output commands 16, input/output module IOC1 sends output commands 17 to the output means O1, where a picture element is output at display device DIS2, for example. In this connection it should be noted that the intermediate module IM also may pass only the output commands 11 to user interface module CUI1 while suppressing the output commands 12.

In the opposite direction, the control direction, the method works analogously. Input commands 21 entered at the input means I1 and relating to the second user interface are transferred by input/output module IOC1 as input commands 22 to intermediate module IM. The latter routes the input commands 22 in modified or, if necessary, coordinate-transformed form to the receiving means RCC of user interface module CUI2. From the (second) input commands 23, user interface module CUI2 generates (first) input commands 24, for instance with the aid of the transformation table MAP, and sends them with the sending means SNC to the intermediate module IM. The input commands 24 are related to the first user interface generated by user interface module PUI2, and are passed as input commands 25 from intermediate module IM to user interface module PUI2. In this case, too, intermediate module IM may perform a coordinate transformation if necessary. In accordance with the respective received input commands 25, user interface module PUI2 sends a control command on link V21 to application module A2, for example.

In FIG. 2, a further variant is indicated by broken lines. At the input means I1, input commands 31 can also be entered with respect to the first user interface, which is assigned to user interface module PUI2. Input/output module IOC1 passes the input commands 31 as input commands 32 to intermediate module IM. Intermediate module IM transfers the input commands 32 as input commands 33 to user interface module PUI2, which then can control the application module A2 accordingly. Application module A2 is operable both via the proprietary, first user interface made available by user interface module PUI2 and via the second user interface of user interface module CUI2, which offers a “common look and feel”.

It is to be understood that further proprietary (first) user interface modules and/or further second user interface modules beside user interface module CUI2 can be connected to intermediate module IM. For example, besides user interface module PUI2, user interface module CUI2 could make further proprietary first user interface modules (not shown) operable under a common user interface.

Control computers IS1, IS2 can be conventional control computers containing, for example, control means CPU1, CPU2, such as processors or processor arrays, storage means MEM1, MEM2, such as random access memories, hard disk drives, or the like, and input/output means EA1, EA2, such as LAN interface cards or the like. Control computers IS1, IS2 may also comprise further components (not shown), such as keyboard and screen (in the case of control computer IS1, these are the output means O1 and the input means I1, for example). Control means CPU1, CPU2 execute the program code of program modules stored in storage means MEM1, MEM2. In the case of control computer IS1, these are the program modules CUI1, CUI2, PUI2, PUI1, and IM as well as the input/output module IOC1. In the case of control computer IS2, these are the modules CUI3, PUI3, PUI4. Not shown in the case of control computers I1, I2 are the respective operating systems, e.g., UNIX or Windows NT, which control and monitor the functions of the respective control computers.

Further variants of the invention as well as arbitrary combinations of the measures set forth in the claims and the description are readily possible.

For example, input/output module IOC1 could form an integral part of the operating system of control computer IS1.

Each of user interface modules CUI1-CUI3 could unite further proprietary user interface modules (not shown) under a common user interface.

In place of user interface modules CUI1-CUI3, a single user interface module could be provided which makes available the functions of all user interface modules CUI1-CUI3 in whole or in part under a common user interface.

The concept according to the invention is cascadable: The user interface modules CUI1-CUI3, too, could be assigned at least one further user interface module which makes available a user interface with which the user interface modules CUI1-CUI3 are operable in the manner according to the invention, for instance via a single preceding user interface.

Input/output module IOC1 as well as input and output means O1, 11 could form part of a user terminal separate from control computer IS1 (cf. user terminal C2).

Unlike the description, the user interface modules CUI1, CUI2, CUI3 according to the invention and the intermediate module IM according to the invention can at least partly be implemented in hardware. In that case it is also possible that a computer, particularly a terminal computer, forms a user interface module according to the invention. For example, a computer could be provided which is of a design similar to that of control terminal C2 and, in addition, performs the functions of user interface module CUI3.

Intermediate module IM could, for example, form part of an operating system of control computer IS1 which is modified in accordance with the invention.

Separation between application module and proprietary user interface module is not absolutely necessary for the implementation of the invention, as is apparent from the example of user interface module PUI1.

Furthermore, it is conceivable that user interface module PUI1, for example, forms part of network element NE1, particularly that it is directly operated by the latter.

The concept according to the invention can be used not only with X-Windows, particularly not only under UNIX, but also in any other operating system environments, such as Windows NT or the like. In the respective operating system, modifications can be made, so that the operating system can perform the functions of an intermediate module IM, for example. An X-Windows environment or a similar, functionally similarly organized environment is preferred only inasmuch as a clear-cut separation is provided between X server and X client, so that a (second) user interface according to the invention can be easily coupled thereto.

1. A method of operating a first user interface module which can generate first output commands for outputting a first user interface at output means and receive input commands related to the first user interface, realized by the steps:
transferring the first output commands or copies thereof are to a second user interface module,
generating in response to the first output commands, the second user interface module second output commands for outputting a second user interface at the output means,
receiving second input commands dependent on operator inputs at input means and related to the second user interface the second user interface module,
the second user interface module generating first input commands related to the first user interface in response to the second input commands, and
transferring the first input commands are to the first user interface module.

2. A method as set forth in claim 1, wherein the first output commands, which relate to the first user interface, are at least partly modified and/or intercepted and discarded, so that the first user interface will not be output by the output means or will be output by the output means only in a restricted form.

3. A method as set forth in claim 1, making the output means and/or resources allocated thereto available to the second user interface module with priority.

4. A method as set forth in claim 1, controlling the output means by an output module, and that the second output commands are transferred to the output module.

5. A method as set forth in claim 1, monitoring the input means by an input module, and that the input module transfers the second input commands, related to the second user interface, to the second user interface module.

6. A method as set forth in claim 1, connecting an intermediate module between the first and second user interface modules for receiving the first output commands from the first user interface module and for transferring the first output commands or copies thereof to the second user interface module and/or for receiving the first input commands from the second user interface module and passing them on to the first user interface module.

7. A method as set forth in claim 6, connecting the intermediate module between, on the one hand, the first and second user interface modules and, on the other hand, the input means and/or the output means.

8. A method as set forth in claim 1, carrying out by a network management system monitoring and controlling a network, with the first user interface module serving to monitor and control a network resource of the network managed by the network management system, particularly a network element.

9. A method as set forth in claim 1, providing the first user interface module for controlling and monitoring an application module, particularly a database application and/or a control and monitoring module for a network element.

10. A (second) user interface module for operating a first user interface module which can generate first output commands for outputting a first user interface at output means and receive input commands related to the first user interface, comprising
receiving means for receiving the first output command or copies thereof,
further generating and sending means for generating and sending second output commands in response to the first output commands for outputting a second user interface at the output means,
where the receiving means that are adapted to receive second input commands related to the second user interface, and
where the generating and sending means are adapted to generate and send first input commands related to the first user interface in response to the second input commands.

11. An intermediate module for operating a first user interface module which can generate first output commands for outputting a first user interface at output means and receive input commands related to the first user interface, comprising:
receiving means for receiving the first output commands, and
sending means for sending the first output commands or copies thereof to a second user interface module, so that in response to the first output commands, the second user interface module can generate second output commands for outputting a second user interface at the output means.

12. An intermediate module for operating a first user interface module which can generate first output commands for outputting a first user interface at output means and receive input commands related to the first user interface, comprising receiving means for receiving first input commands sent by a second user interface module and related to the first user interface, which first input commands were generated by the second user interface module in response to second input commands related to a second user interface, and that it comprises sending means for sending the first input commands to the first user interface module.

13. A network management system or a computer of a network management system, comprising a user interface module as set forth in claim 10 and/or by an intermediate module as set forth in claim 11 and/or by an intermediate module as set forth in claim 12.

14. A user interface module as set forth in claim containing program code which can be executed by a control means of a computer, particularly of a computer of a network management system.

15. A storage means, particularly a floppy disk, CD-ROM, Digital Versatile Disc, hard disk drive, or the like, having a user interface module according to claim 14.

16. A method of operating a first user interface module which can generate first output commands for outputting a first graphical user interface at output means and receive input commands related to the first user interface, realized by the steps
transferring the first output commands or copies thereof to a second user interface module,
generating in response to the first output commands, the second user interface module second output commands for outputting a second graphical user interface at the output means,
receiving second input commands dependent on operator inputs at input means and related to the second graphical user interface, by the second user interface module
generating in response to the second input commands, the second user interface module first input commands related to the first graphical user interface, and
transferring the first input commands to the first user interface module.

17. A (second) user interface module for operating a first user interface module which can generate first output commands for outputting a first graphical user interface at output means and receive input commands related to the first graphical user interface, comprising
receiving means for receiving the first output commands or copies thereof,
further generating and sending means for generating and sending second output commands in response to the first output commands for outputting a second graphical user interface at the output means,
where the receiving means are adapted to receive second input commands related to the second user interface, and
where the generating and sending means are adapted to generate and send first input commands related to the first graphical user interface in response to the second input commands.

18. An intermediate module for operating a first user interface module which can generate first output commands for outputting a first graphical user interface at output means and receive input commands related to the first graphical user interface, comprising
receiving means for receiving the first output commands, and
sending means for sending the first output commands or copies thereof to a second user interface module, so that in response to the first output commands, the second user interface module can generate second output commands for outputting a second graphical user interface at the output means.

19. An intermediate module for operating a first user interface module which can generate first output commands for outputting a first graphical user interface at output means and receive input commands related to the first graphical user interface, comprising receiving means for receiving first input commands sent by a second user interface module and related to the first graphical user interface, which first input commands were generated by the second user interface module in response to second input commands related to the second user interface, and sending means for sending the first input commands to the first user interface module.

20. A storage means, particularly a floppy disk, CD-ROM, Digital Versatile Disc, hard disk drive, or the like, having a second user interface module stored thereon for operating a first user interface module which can generate first output commands for outputting a first graphical user interface at output means and receive input commands related to the first graphical user interface, the second user interface module containing program code which can be executed by a control means of a computer, particularly of a computer of a network management system, comprising
receiving means for receiving the first output commands or copies thereof,
further generating and sending means for generating and sending second output commands in response to the first output commands for outputting a second graphical interface at the output means,
where the receiving means are adapted to receive second input commands related to the second graphical user interface, and
where the generating and sending means are adapted to generate and send first input commands related to the first graphical user interface in response to the second input commands.

21. A storage means, particularly a floppy disk, CD-ROM, Digital Versatile Disc, hard disk drive, or the like, having an intermediate module stored thereon for operating a first user interface module which can generate first output commands for outputting a first graphical user interface at output means and receive input commands related to the first graphical user interface, and which contains program code which can be executed by a control means of a computer, particularly of a computer of a network management system, comprising
receiving means for receiving the first output commands, and
sending means for sending the first output commands or copies thereof to a second user interface module, so that in response to the first output commands, the second user interface module can generate second output commands for outputting a second graphical user interface at the output means.

22. A storage means, particularly a floppy disk, CD-ROM, Digital Versatile Disc, hard disk drive, or the like, having an intermediate module stored thereon for operating a first user interface module which can generate first output commands for outputting a first graphical user interface at output means and receive input commands related to the first graphical user interface, and which contains program code which can be executed by a control means of a computer, particularly of a computer of a network management system, comprising receiving means for receiving first input commands sent by a second user interface module and related to the first graphical user interface, which first input commands were generated by the second user interface module in response to second input commands related to a second graphical user interface, and that it comprises sending means for sending the first input commands to the first user interface module.
